(19) United States
(12) Patent Application Publication
(10) Pub. No.: US 2015/0142788 A1
(43) Pub. Date: May 21, 2015

(54) Repair Information Management Apparatus, Repair Information Management System, and Repair Information Management Method

(71) Applicant: FUJIFILM Corporation, Tokyo (JP)

(72) Inventor: Kazunari TOYAMA, Kanagawa (JP)

(21) Appl. No.: 14/546,907

(22) Filed: Nov. 18, 2014

(30) Foreign Application Priority Data
Nov. 19, 2013 (JP) 2013-239199

(51) Int. Cl. G06F 17/30; G06Q 10/00

(52) U.S. Cl. CPC G06F 17/30867; G06F 17/3053; G06Q 10/20
USPC 707/723

(57) ABSTRACT

A database stores a parts list, a tools and materials list, a repair information list, and an equipment list. The parts list and the tools and materials list are associated with regulation information, which indicates that the parts, the tools, and the materials are subject to a regulation, and updated every time a new regulation is imposed. The repair information list is associated with an indicator which indicates whether a repair is compliant with the regulation, and updated every time a repair is performed. The equipment list is associated with an indicator which indicates whether equipment is compliant with the regulation, and updated every time one of the parts list, the tools and materials list, and the repair information list is updated. Those which are not compliant with the regulation are extracted from each list stored in the database, and displayed on a regulatory compliance check screen.

### CROSS-REFERENCE TO RELATED APPLICATIONS

The present application claims priority under 35 U.S.C. §119 to Japanese Patent Application No. 2013-239199, filed Nov. 19, 2013. The above application is hereby expressly incorporated by reference, in its entirety, into the present application.

### BACKGROUND OF THE INVENTION

1. Field of the Invention

The present invention relates to a repair information management apparatus, a repair information management system, and a repair information management method for managing repair information of medical equipment.

2. Description Related to the Prior Art

Repair information management systems for managing repair information of medical equipment are known, such as the one disclosed in Japanese Patent Laid-Open Publication No. 2002-015082. The disclosed repair information management system is a computer system which receives repair requests from users of the medical equipment, creates repair plans based on failure circumstances, and manages failure information. The repair information management system comprises intermediary center terminals and repair center terminals. The intermediary center terminal is disposed in an intermediary center that receives the repair requests from the users. The repair center terminal is disposed in a repair center, in which repairs are performed. The repair center terminal manages the repair information transmitted from the intermediary center. The intermediary center terminal is used for obtaining failure descriptions based on information provided by the user and creating repair plans. The created repair plans are transmitted to the user, and the repair plan selected by the user is transmitted to the repair center terminal. The repair center terminal manages information related to the repair.

The medical equipment and the repair of the medical equipment (including discarding repair parts) are regulated by laws and the like. For example, the use of replacement parts or the like may be prohibited or restricted depending on their materials. Once the medical equipment is approved, any replacement after the approval may be prohibited.

The Japanese Patent Laid-Open Publication No. 2002-15082 did not give consideration to the above-described regulations. For this reason, the problems may arise e.g. the medical equipment may be repaired using a part made from an unapproved material or treated as a non-compliant product, which is not compliant with the regulation, due to a repair.

These problems do not occur if repair technicians are well aware of laws and regulations. However, there have been a growing number of regulations with various effective dates, so that it is actually very difficult for the repair technicians to perform the repairs to be compliant with every regulation. Particularly, due to recent globalization, medical equipment of a domestic manufacturer has been exported to many countries and such medical equipment must be repaired in ways compliant with the regulations of those countries. However, it is extremely difficult to keep track of the regulations of many countries and perform the repairs of the medical equipment to be compliant with the regulations.

### SUMMARY OF THE INVENTION

An object of the present invention is to provide a repair information management apparatus, a repair information management system, and a repair information management method, which facilitate and ensure a repair to be compliant with a regulation.

In order to achieve the above and other objects, the repair information management apparatus, according to the present invention, for managing repair information of medical equipment comprises an operation screen distributor and a database. The operation screen distributor distributes operation screens to a plurality of terminals through a network. The repair information is inputted through and displayed on the operation screen. The database stores regulation information related to a regulation on the medical equipment or each part constituting the medical equipment. The regulation information is stored in the database for the purpose of displaying whether the medical equipment or the part constituting the medical equipment is a compliant product that is compliant with the regulation or a non-compliant product that is not compliant with the regulation on the operation screen.

It is preferred that the repair information management apparatus further comprises an operation screen generator for generating the operation screen. The operation screen generator generates the operation screen based on the regulation information. The operation screen displays whether the equipment or the part constituting the equipment is the compliant product or the non-compliant product.

It is preferred that the operation screen generator generates the operation screen in which additional information is added to the medical equipment or the part constituting the medical equipment displayed. The additional information indicates whether the medical equipment or the part constituting the medical equipment is the compliant product or the non-compliant product.

It is preferred that the operation screen generator determines, based on the regulation information, whether to display the medical equipment or the part constituting the medical equipment on the operation screen, and generates the operation screen.

It is preferred that the regulation information stored in the database includes regulation information related to the regulation on tools and materials used for a repair of the medical equipment, in addition to the regulation information related to the regulation on the medical equipment or each part constituting the medical equipment.

It is preferred that the operation screens include a parts selection screen for displaying selectable parts fora repair of the medical equipment and allowing selecting the part to be used for the repair from the selectable parts.

It is preferred that the operation screens include a parts list display screen for displaying a list of the parts constituting the medical equipment.

It is preferred that the operation screens include a medical equipment list display screen for displaying a list of the medical equipment.

It is preferred that the operation screens include a repair history display screen for displaying a repair history.

It is preferred that the operation screens include a time-series compliance check screen for chronologically displaying, for the medical equipment or the part constituting the medical equipment, whether the medical equipment or the part constituting the medical equipment is the compliant product or the non-compliant product.

A repair information management system, according to the present invention, for managing repair information of medical equipment comprises a plurality of terminals and a repair information management apparatus. The repair information management apparatus comprises an operation screen distributor and a database. The operation screen distributor distributes operation screens to the terminals through a network. The repair information is inputted through and displayed on the operation screen. The database stores regulation information related to a regulation on the medical equipment or each part constituting the medical equipment. The regulation information is stored in the database for the purpose of displaying whether the medical equipment or the part constituting the medical equipment is a compliant product that is compliant with the regulation or a non-compliant product that is not compliant with the regulation on the operation screen.

The method, according to the present invention, for managing repair information of medical equipment comprises a distribution step, a determination step, and a display step. In the distribution step, the operation screens are distributed to a plurality of terminals through a network. The repair information is inputted through and displayed on the operation screen. In the determination step, a database which stores regulation information related to a regulation is consulted and whether the medical equipment or a part constituting the medical equipment is a compliant product that is compliant with the regulation or a non-compliant product that is not compliant with the regulation is determined. In the display step, whether the medical equipment or the part constituting the medical equipment is the compliant product or the non-compliant product is displayed on the operation screen.

According to the present invention, the database has the regulation information related to the regulation on the medical equipment or each part constituting the medical equipment. This facilitates and ensures the repair to be compliant with the regulation. In a case where the medical equipment is subject to a regulation, the medical equipment must be compliant with the regulation even after the repair. In other words, the medical equipment must be repaired in a manner compliant with the regulation. It is also necessary to monitor whether each part of the medical equipment is subject to the regulation and to perform the repair with the use of the parts which are compliant with the regulation. Thus, the repair compliant with the regulation is performed. According to the present invention, the repair compliant with the regulation is performed easily and surely.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view illustrating a repair information management system;

FIG. 2 is an explanatory view of data stored in a DB;

FIG. 3 is an explanatory view illustrating a repair information list;

FIG. 4 is an explanatory view of a parts list;

FIG. 5 is an explanatory view illustrating a tools and materials list;

FIG. 6 is an explanatory view of an equipment list;

FIG. 7 is a schematic diagram of a repair information management apparatus;

FIG. 8 is an explanatory view illustrating operation steps for selecting an operation mode;

FIG. 9 is an explanatory view illustrating a mode selection screen;

FIG. 10 is an explanatory view illustrating operation steps in a repair mode;

FIG. 11 is an explanatory view illustrating a repair information input screen;

FIG. 12 is an explanatory view illustrating operation steps in a regulation information input mode;

FIG. 13 is an explanatory view illustrating a regulation information input screen;

FIG. 14 is an explanatory view illustrating operation steps in a regulatory compliance check mode; and

FIG. 15 is an explanatory view illustrating a regulatory compliance check screen.

### DESCRIPTION OF THE PREFERRED EMBODIMENTS

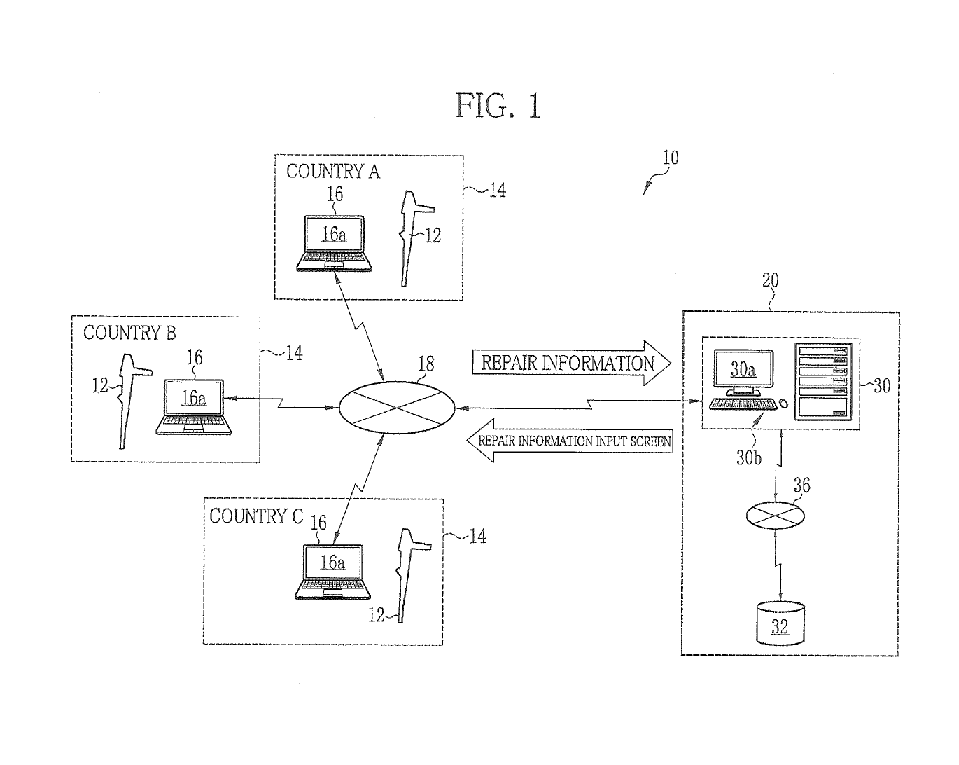

In FIG. 1, a repair information management system 10 is composed of user terminals 16, which are provided in repair centers 14 for endoscopes 12 located in various countries and regions, and a repair information management apparatus 20 connected to each of the user terminals 16 through a network 18 such as the Internet.

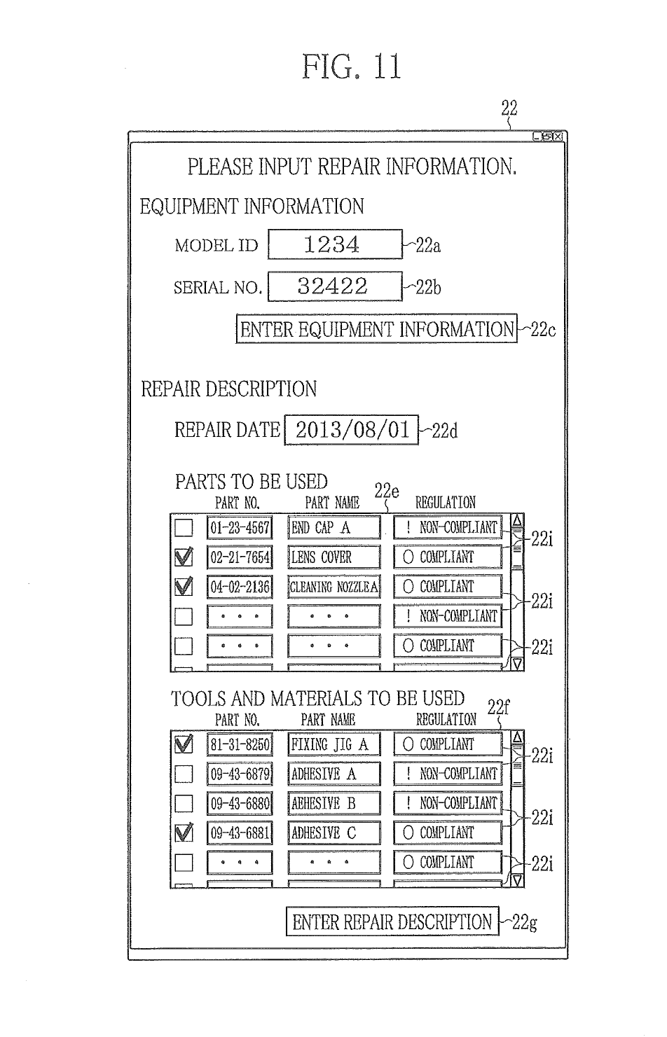

The repair information management system 10 distributes (or delivers) repair information input screens (operation screens) 22 (see FIG. 11) from the repair information management apparatus 20 to the user terminals 16, to collectively manage repair information transmitted from the user terminals 16 to the repair information management apparatus 20 through the repair information input screens 22. The repair information is inputted through the user terminal 16. The repair information is information related to a repair of the endoscope 12 and includes the model ID and the serial number, which identify the repaired endoscope 12, and a repair description such as the repair date, the part number of a part replaced by the repair, and the tool number or the material number of a tool or a material (e.g. an instrument, a jig, a screw, an adhesive, a solder, or the like).

The repair center 14 is a facility where the faulty endoscope 12 (medical equipment) is repaired. The endoscope 12 which needs repair is sent to the repair center 14 from a client, such as a hospital where the endoscope 12 is used, in the region or country in which the repair center 14 is located. After the faulty endoscope 12 is delivered to the repair center 14, the user terminal 16 is operated to access the repair information management apparatus 20, and the repair is performed in accordance with the repair information input screen 22, which is delivered from the repair information management apparatus 20. After the repair is completed, the endoscope 12 is returned to the client.

The user terminal 16 is, for example, a notebook personal computer, and communicates with the repair information management apparatus 20 in accordance with a predetermined communications protocol such as HTTP (Hyper Text Transfer Protocol). Various screens (e.g. the repair information input screen 22) are delivered as web page data from the repair information management apparatus 20 to the user terminals 16. In the web page data, a source code is described with a Hyper Text Markup Language such as XML (Extensible Markup Language), which is used on the WWW (World Wide Web).

Browser software is installed on the user terminal 16. The browser software analyzes and executes the source code. Thereby, the page data of the operation screen delivered to the user terminal 16 is displayed on a display 16a of the user terminal 16. Note that the browser software is a standard one installed on a commercially available personal computer or the like.

The repair information management apparatus 20 is disposed in a company which operates (or runs) the repair information management system 10. The repair information management apparatus 20 comprises an application server 30 and a database (DB) 32, which are connected to each other through a network 36 such as a LAN.

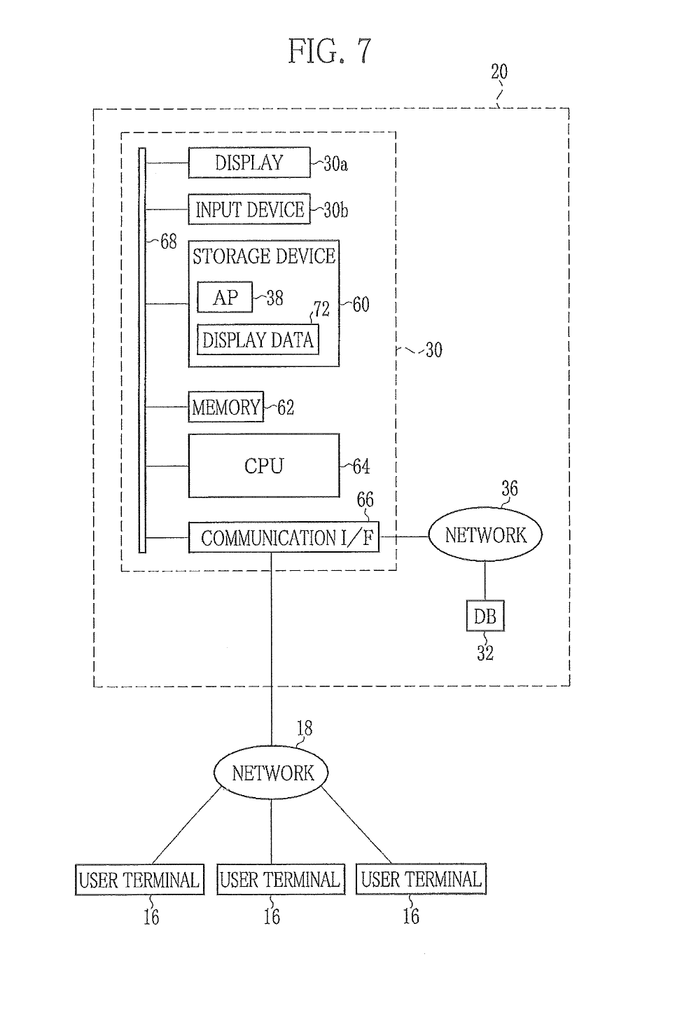

The application server 30 is, for example, a desktop personal computer. The application server 30 operates in three operation modes: a repair mode, a regulation information input mode, and a regulatory compliance check mode, in accordance with an application program (AP) 38 (see FIG. 7), which will be described below.

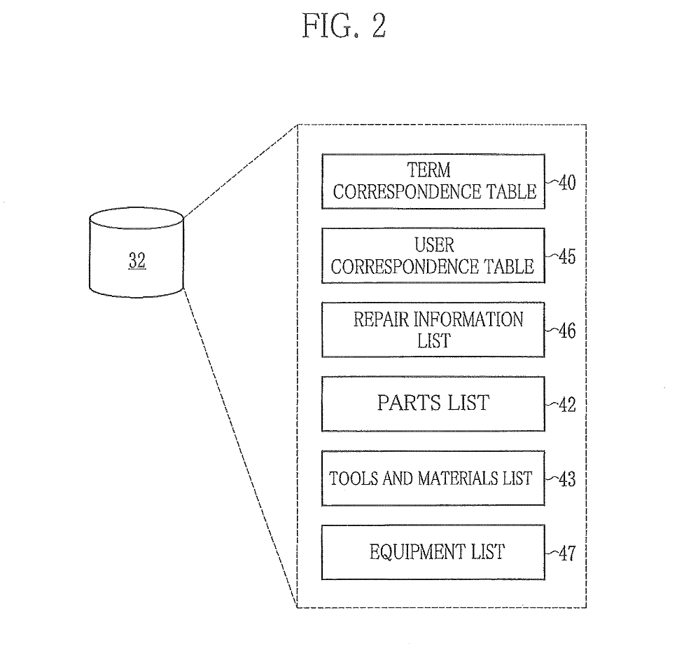

The repair mode is an operation mode in which the repair information input screen 22 is distributed (or delivered) to the user terminal 16 and the repair is performed based on the repair information input screen 22. In the repair mode, the repair information input screen 22 is generated based on a term correspondence table 40 (see FIG. 2), which will be described below, and with the use of a country-specific language selected by a user. The user performs the repair by following contents of the repair information input screen 22, which is displayed in the country-specific language. Various operation screens displayed in the regulation information input mode and the regulatory compliance check mode are also displayed in the language selected by the user, in a manner similar to the above.

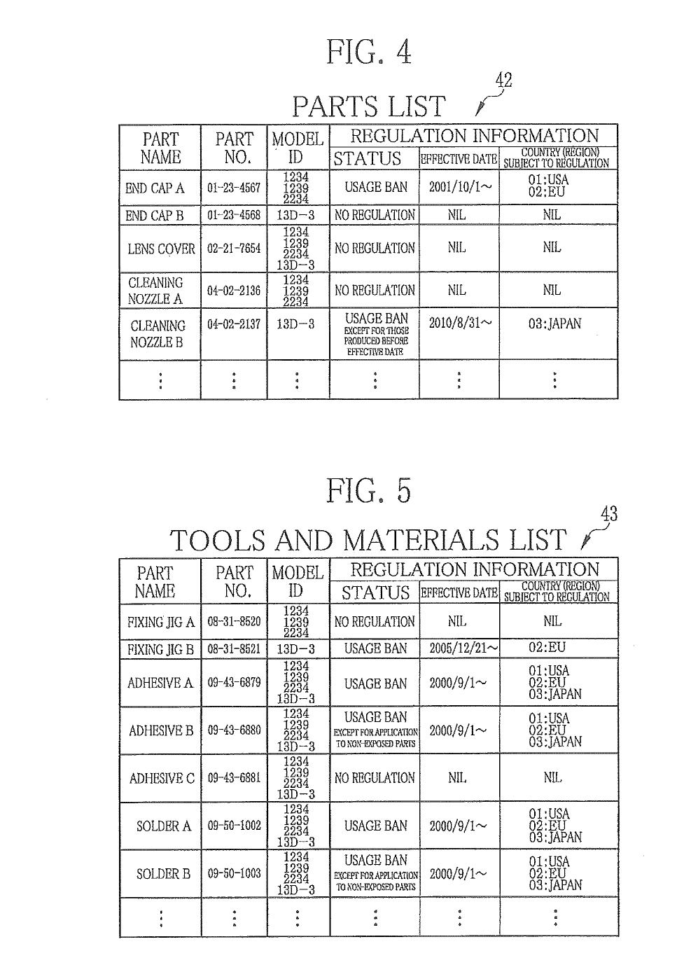

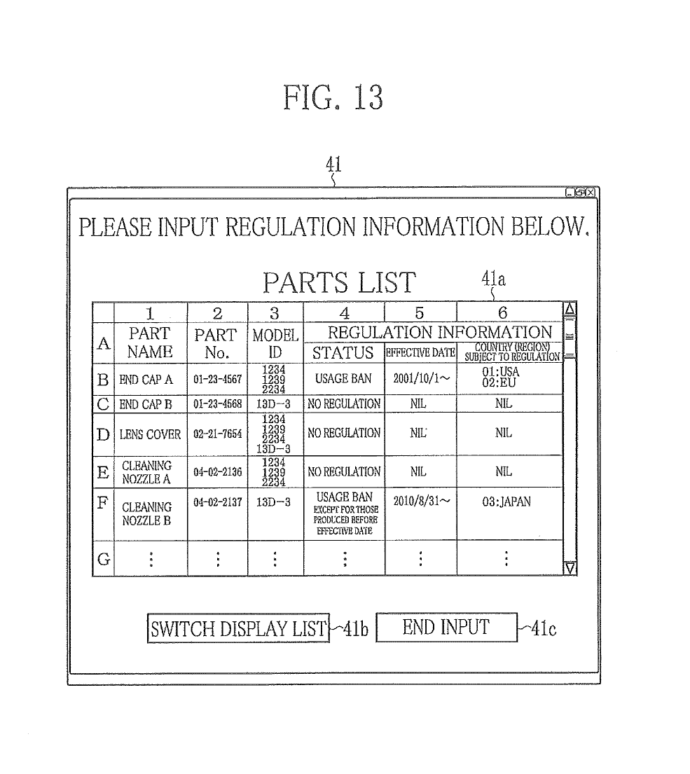

The regulation information input mode is an operation mode in which regulation information is inputted by following contents of a regulation information input screen (operation screen) 41 (see FIG. 13) displayed on a display 30a of the application server 30. The regulation information is composed of types of parts, tools, and materials whose use or replacement is banned or restricted by a law (or a regulation), the effective date of the law, and a country or region subject to the law. The regulation information is stored in association with each part in a parts list 42 (see FIGS. 2 and 4) and each tool and each material in a tools and materials list 43 (see FIGS. 2 and 5), which will be described below. Note that the regulation information includes not only the information related to the restrictions by laws but also information related to various other regulations such as orders or notifications from the authorities concerned, municipal laws of municipalities, and voluntary restraints by manufacturers. In this embodiment, the regulation information is inputted to the application server 30 (in other words, an entity which runs or operates the repair information management system 10 inputs the regulation information), by way of example. Alternatively, the regulation information input screen 41 may be delivered to the user terminal 16, and a user in the repair center 14 may input the regulation information through the user terminal 16.

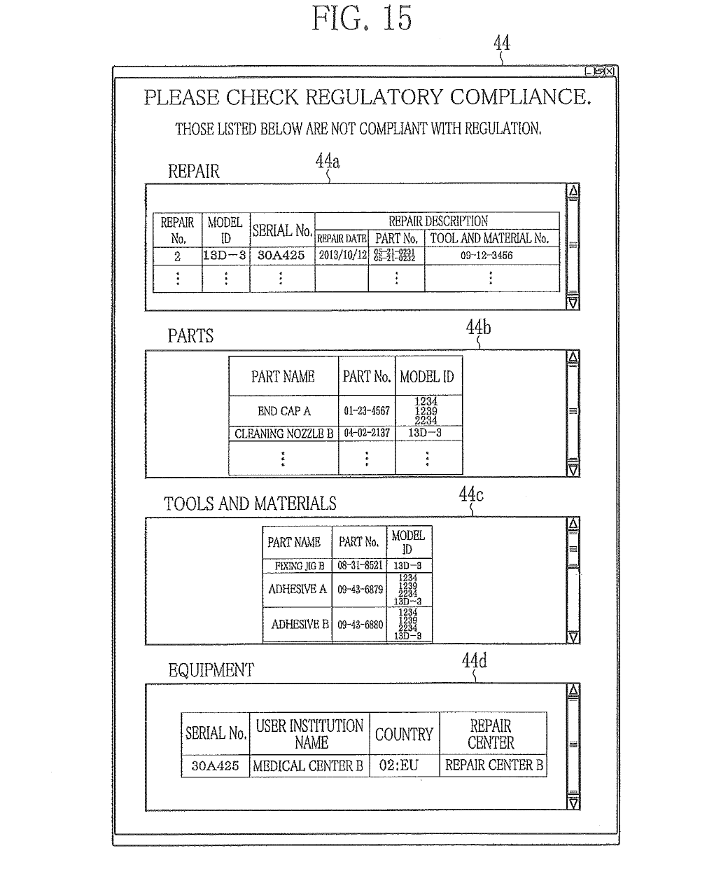

The regulatory compliance check mode is an operation mode for checking regulatory compliance (the state of compliance with the regulation) through a regulatory compliance check screen (operation screen) 44 (see FIG. 15) displayed on the display 30a of the application server 30. The regulatory compliance (the state of compliance with the regulation) refers to whether the endoscope 12 was repaired in compliance with the regulation, or the endoscope 12 repaired or the endoscope 12 being managed is compliant with the regulation, in other words, whether the endoscope 12 repaired or the endoscope 12 being managed is a compliant product that is compliant with the regulation or a non-compliant product that is not compliant with the regulation, for example. Note that, in this embodiment, the regulatory compliance information is checked (or inputted) through the application server 30 (in other words, the entity which runs or operates the repair information management system 10 checks the regulatory compliance), by way of example. Alternatively, the regulatory compliance check screen 44 may be delivered to the user terminal 16 to allow a user in the repair center 14 to check (or input) the regulatory compliance information through the user terminal 16.

In FIG. 2, the DB 32 is composed of a work station and DBMS (Database Management System) installed on the work station. The DB 32 stores various types of data used by the application server 30 to execute various functions in each of the three operation modes. In this embodiment, the DB 32 stores the term correspondence table 40, a user correspondence table 45, a repair information list 46, the parts list 42, the tools and materials list 43, and an equipment list 47.

In the term correspondence table 40, each of the terms (words) to be displayed in the various operation screens (e.g. the repair information input screen 22, the regulation information input screen 41, and the regulatory compliance check screen 44) is associated with country-specific terms, which are translations of the term indifferent languages. The user of the repair information management system 10 (the user terminals 16 and the application server 30) selects the language to be used in the operation screen from the languages specified in the term correspondence table 40. The text on the operation screens is translated into the selected language and displayed. Note that, in this embodiment, English is selected as the language used in the operation screens by way of example.

In the user correspondence table 45, each user ID, which is assigned to each user, is associated with the language the user uses. The user ID is assigned to the user at the user's first access to the repair information management system 10. Also at the user's first access to the repair information management system 10, the user selects the language through a selection screen (the operation screen) for selecting a language, and the selected language is associated with the user ID.

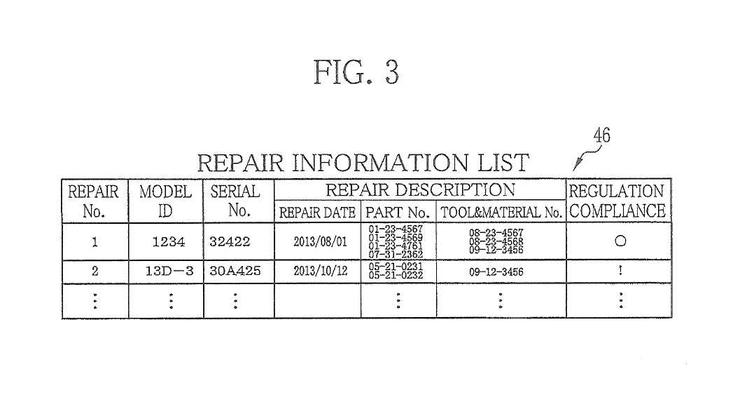

As shown in FIG. 3, the repair information list 46 is a list of pieces of the repair information stored. Each piece of the repair information corresponds to each repair. In each piece of the repair information, a repair serial number assigned to each repair is associated with information inputted through the user terminal 16, for example, the model ID and the serial number of the repaired endoscope 12 and the repair description (e.g. the repaired date, the part number of a replaced part, and the tool number or the material number of a tool or a material used).

In the repair mode, whether the repair performed is in compliance with the regulation is determined, which will be described below. An indicator or sign that indicates the result of the determination is also associated with the repair information. In this embodiment, an indicator “o” is assigned to the repair in a case where the repair performed is in compliance with the regulation, in other words, in a case where the endoscope (equipment or product) to be repaired, part(s), tool(s), and material(s) to be used for the repair are subject to a regulation and the repair was performed in a manner compliant with the regulation, or in a case where the product to be repaired, part (s), tool(s), and material (s) to be used for the repair are not subject to any regulation (free from any regulation). An indicator or sign “!” is assigned to the repair in a case where the repair performed is not compliant with the regulation, in other words, in a case where the product to be repaired, part(s), tool(s), and material (s) to be used for the repair are subject to the regulation but the repair was not performed in a manner compliant with the regulation. Thus, the repair information list 46 functions as a repair history showing descriptions of the repair performed to each equipment.

As shown in FIG. 4, in the parts list 42, each part constituting the endoscope 12 is associated with a part number and model ID(s) of the endoscope(s) 12 in which the part is used. In the regulation information input mode, the regulation information of a part subject to the regulation is inputted to the parts list 42, and thereby the parts list 42 is updated. The regulation information includes status (information indicating that the use or the replacement of the part is prohibited or restricted (or permitted under predetermined conditions), the effective date of the regulation (or a statute or law), and the country or region subject to the regulation. Thus, in the parts list 42, each part is also associated with the regulation information.

As shown in FIG. 5, in the tools and materials list 43, each of tools and materials used for a repair of the endoscope 12 is associated with a part number (or tool number or material number) and model ID(s) of the endoscope(s) for which the tool or the material is used. The tools and materials list 43 is associated with the regulation information and updated when the regulation information is inputted in the regulation information input mode, in the manner similar to the parts list 42.

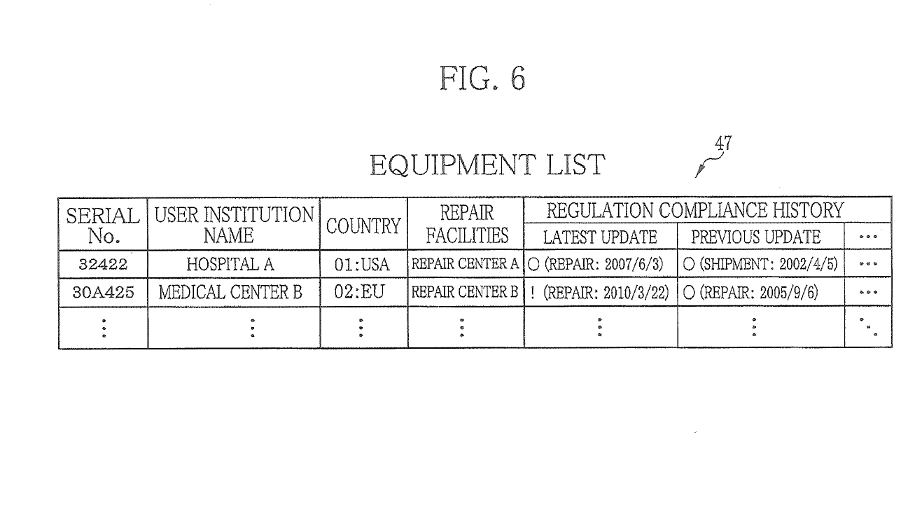

As shown in FIG. 6, in the equipment list 47, each endoscope 12 is associated with the serial number, the name of the facility where the endoscope 12 is used, the name of the country where the endoscope 12 is used, and the repair center 14 which performs the repair of the endoscope 12. The equipment list 47 is updated when one of the repair information list 46, the parts list 42, and the tools and materials list 43 is updated. In a case where the endoscope 12 is compliant with the regulation, in other words, in a case where the endoscope 12 is a compliant product, the indicator “o”, which indicates that the endoscope 12 is compliant with the regulation, is associated with the endoscope 12 in the equipment list 47. In a case where the endoscope 12 is not compliant with the regulation, in other words, in a case where the endoscope 12 is a non-compliant product, the indicator “!”, which indicates that the endoscope 12 is not compliant with the regulation, is associated with the endoscope 12 in the equipment list 47. Thus, in the equipment list 47, each endoscope 12 is associated with the indicator or sign, which indicates whether the endoscope 12 is in compliance with the regulation or not. Note that an indicator or sign is added every time the state of compliance with the regulation is changed. In addition to the changed indicator or sign, the date of the change and a reason for the change (e.g. a change due to a repair or a new regulation which has become effective) are also added. Thus, the equipment list 47 allows checking the current state of compliance with the regulation, the history of compliance with the regulation(s), and the reasons for the changes in the compliance with the regulation(s).

As shown in FIG. 7, the application server 30 is composed of a computer (e.g. a personal computer or a work station) and a control program (e.g. operating system) and the AP 38, which are installed on the computer. The AP 38 allows the computer to function as the application server 30.

The application server 30 comprises the display 30a, an input device 30b, a storage device 60, a memory 62, a CPU 64, and a communication I/F 66, which are connected to each other through a data bus 68. The display 30a is a liquid crystal monitor, for example. The input device 30b is a keyboard or a mouse, for example.

The storage device 60 is, for example, a hard disk drive, which is an internal storage built in the body of the application server 30. The storage device 60 stores the control program, the AP 38 such as application server software, images and messages displayed during the execution of the AP 38, and display data 72 used for displaying the various operation screens. The AP 38 is a program which allows the computer to execute various functions. Note that the display data 72 includes template information, based on which the various operation screens are generated.

The memory 62 is a working memory used by the CPU 64 in executing the processes. The CPU 64 loads the control program, which is stored in the storage device 60, onto the memory 62 and executes the processes in accordance with the control program. Thereby the CPU 64 centrally controls each section of the computer. The communication I/F 66 comprises an interface for communicating with the networks 18 and 36. The application server 30 communicates with the DB 32 and the user terminal 16 through the communication I/F 66 and the networks 18 and 36.

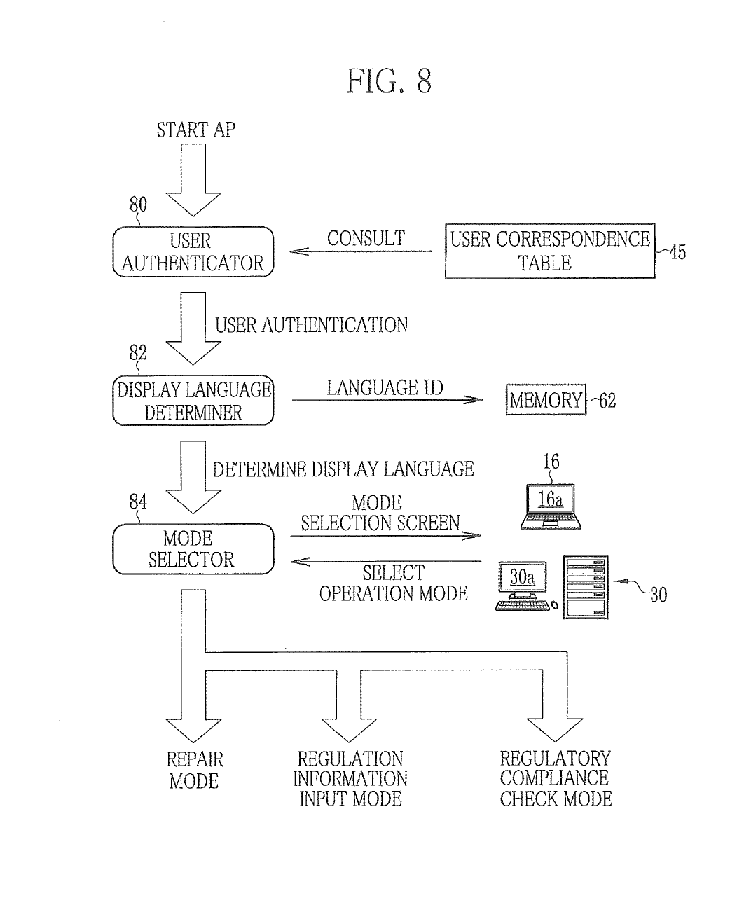

As shown in FIGS. 8, 10, 12, and 14, at or after the start of the AP 38, the CPU 64, working together with the memory 62, functions as a user authenticator 80, a display language determiner 82, a mode selector 84, a repair information input screen generator 86, a repair information input screen distributor 88, a determiner 89, a DB updater 90, a regulation information input screen generator 92, and a regulatory compliance check screen generator 94.

Hereinafter, an operation of each section of the application server 30 at or after the start of the AP 38 is described in sequence.

(From Start of AP to Selection of Operation Mode)

First, an operation of each section of the application server 30 at or after the start of the AP 38 and before the selection of the operation mode is described.

As shown in FIG. 8, the user authenticator 80 is activated at or after the start of the AP 38. The user authenticator 80 receives a request (access request) to access the repair information management system 10 from a user and authenticates the user. The access request is inputted through the user terminal 16 or the application server 30. The access request is transmitted to the user authenticator 80 when the company which operates the repair information management system 10 inputs the user ID to its website on the network 18, for example. Upon receiving the access request, the user authenticator 80 verifies the user ID, which is inputted together with the access request, against the user correspondence table 45, and thereby authenticates the user.

Upon the completion of the user authentication, the display language determiner 82 is activated. The display language determiner 82 verifies the user ID of the authenticated user against the user correspondence table 45, and determines the language corresponding to the language ID which is associated with the user ID, as the language to be displayed in the subsequent screens. The display language determiner 82 allows the memory 62 to store the language ID of the language thus determined.

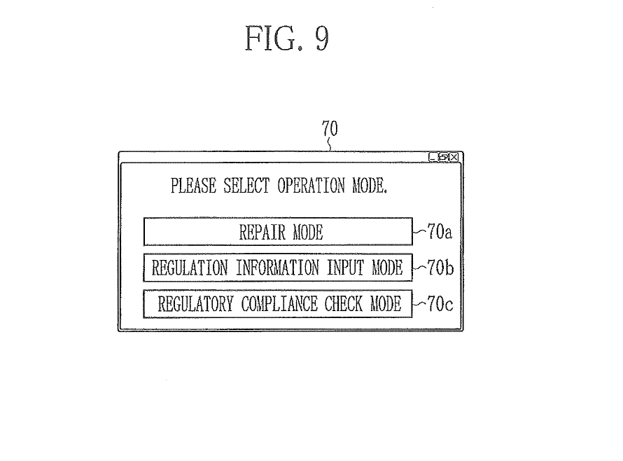

After the determination of the display language is completed, the mode selector 84 is activated. The mode selector 84 generates a mode selection screen 70 (see FIG. 9) based on the language ID stored in the memory 62, the term correspondence table 40, and the template information stored in the storage device 60 and with the use of the country-specific terms of the language which corresponds to the language ID, and delivers the mode selection screen 70 to the user terminal (the user terminal 16 or the application server 30 itself) accessing the repair information management system 10.

As shown in FIG. 9, the mode selection screen 70 comprises an operation tag 70a, which allows the application server 30 to operate in the repair mode, an operation tag 70b, which allows the application server 30 to operate in the regulation information input mode, and an operation tag 70c, which allows the application server 30 to operate in the regulatory compliance check mode. The user selects the operation tag 70a, 70b, or 70c to allow the application server 30 to operate in the repair mode, the regulation information input mode, or the regulatory compliance check mode, respectively.

Next, an operation of each section of the application server 30 in each of the repair mode, the regulation information input mode, and the regulatory compliance check mode is described.

(Repair Mode)

First, an operation of each section of the application server 30 in the repair mode is described.

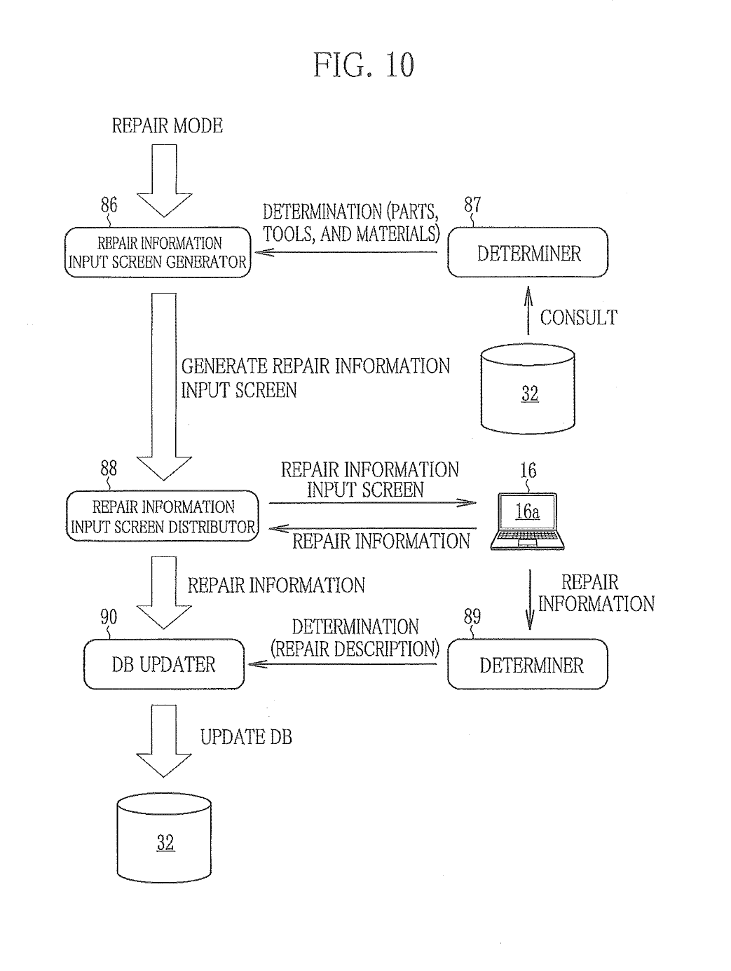

As shown in FIG. 10, in a case where the repair mode is selected through the mode selection screen 70, in other words, in a case where the operation tag 70a is selected on the mode selection screen 70, the repair information input screen generator 86, a determiner 87, the repair information input screen distributor 88, the determiner 89, and the DB updater 90 are activated.

The repair information input screen generator 86 generates the repair information input screen 22 based on the language ID stored in the memory 62 by the display language determiner 82, the term correspondence table 40, and the template information stored as the display data 72 in the storage device 60 and with the use of the country-specific terms of the language which corresponds to the language ID. The repair information input screen distributor 88 delivers the repair information input screen 22, which is generated by the repair information input screen generator 86, to the user terminal 16.

As shown in FIG. 11, the repair information input screen 22 comprises a model ID input box 22a, a serial number input box 22b, an equipment enter tag 22c, a repair date input box 22d, a parts selection section 22e, a tools and materials selection section 22f, and a repair description enter tag 22g.

The model ID of the endoscope 12 to be repaired is inputted to the model ID input box 22a. The serial number of the endoscope 12 to be repaired is inputted to the serial number input box 22b. The model ID and the serial number are inputted to the input boxes 22a and 22b, respectively, and then the equipment enter tag 22c is operated. Thereby, the endoscope 12 to be repaired is identified.

When the date of repair (repair date) is inputted to the repair date input box 22d after the endoscope 12 to be repaired is identified, the parts associated with the endoscope 12 to be repaired are extracted from the parts list 42 and displayed as a list of selectable parts in the parts selection section 22e. The tools and the materials associated with the endoscope 12 to be repaired are extracted from the tools and materials list 43 and displayed as a list of selectable tools and materials in the tools and materials selection section 22f.

A check box 22h is provided to the side of each of the parts, the tools, and the materials displayed in the parts selection section 22e and the tools and materials selection section 22f. The part, the tool, or the material used for the repair is selected by checking the check box 22h with a click operation with the cursor placed on the check box 22h, for example.

An indicator display section 22i is provided to the side of each of the parts, the tools, and materials displayed in the parts selection section 22e and the tools and materials selection section 22f. The indicator display section 22i displays whether each part or the like is compliant with the regulation or not, in other words, whether each part or the like is a compliant product or a non-compliant product. The indicator “o” is displayed in the indicator display section 22i in the case where the part, the tool, or the material is compliant with the regulation, in other words, in the case where the part, tool, or the material is subject to the regulation and compliant with the regulation, or free from the regulation. The indicator “!” is displayed in the indicator display section 22i in the case where the part, the tool, or the material is subject to the regulation but not compliant with the regulation.

The determiner 87 determines which one of the indicators “o” or “!” to be displayed in the indicator display section 22i. The determiner 87 makes the determination based on the information stored in the DB 32. To be more specific, the determiner 87 consults the parts list 42 and the tools and materials list 43 to check whether each of the parts, the tools, and the materials, displayed in the parts selection section 22e and the tools and materials selection section 22f, is subject to the regulation. Then, the determiner 87 consults the equipment list 47 to check the country where the endoscope 12 (the endoscope 12 with the serial number inputted to the serial number input box 22b) to be repaired is used. Based on the results of the consultation of the parts list 42, the tools and materials list 43, and the equipment list 47, the determiner 87 determines whether the part, the tool, or the material to be used is compliant with the regulation of the country where the endoscope 12 to be repaired is used. As a result of the determination, the indicator “o” is displayed in a case where the part, the tool, or the material is compliant with the regulation and the indicator “!” is displayed in a case where the part, the tool, or the material is not compliant with the regulation. Note that the indicator “o” is also displayed for equipment, a part, a tool, or a material which is free from any regulation. For example, there may exist a regulation which prohibits the use of a part A in a product A even though the part A is free from the regulation. In other words, the part A itself is free from the regulation but the product A, in which the part A is used, is subject to the regulation. In this case, the indicator “!” is displayed for the part A in a case where the endoscope 12 to be repaired is the product A. The indicator “o” is displayed for the part A in a case where the endoscope 12 to be repaired is other than the product A.

As described above, the repair is performed while the part, the tool, and the material to be used for the repair are selected through the repair information input screen 22. Since the repair information input screen 22 displays the indicators that indicate whether the parts, the tools, and the materials to be used for the repair are compliant with the regulation, the repair information input screen 22 prevents the user from selecting the parts, the tools, and the materials which are not compliant with the regulation and making the products non-compliant with the regulation due to the repair.

The repair description enter tag 22g is provided to enter (or confirm) the items inputted through the repair information input screen 22. Upon the operation of the repair description enter tag 22g, the information inputted to and selected in the repair information input screen 22 is associated with the indicator, which indicates whether the repair performed is in compliance with the regulation, and thereby the repair information for a single case of repair is generated. The indicators associated as the repair information includes the indicator “o” that indicates that the repair performed is compliant with the regulation and the indicator “!” that indicates that the repair performed is not compliant with the regulation. The determiner 89 determines which one of the indicators to be associated (and displayed). The determiner 89 determines that the repair is not compliant with the regulation and associates the repair information with the indicator “!” in a case where a part, a tool, or a material with the indicator “!” displayed in the indicator display section 22i is used for the repair. The determiner 89 determines that the repair is compliant with the regulation and associates the repair information with the indicator “o” in a case where only parts, tools, and materials with the indicators “o” displayed in the indicator display section 22i are used.

The repair information for the single case (the current case) of repair is inputted to the DB updater 90. The DB updater receives the inputted repair information (the repair information for the current case) and adds the received repair information to the repair information list 46 (see FIG. 3) stored in the DB 32, and thus updates the DB 32.

In a case where the repair information (the repair information for the current case) inputted to update the repair information list 46 is associated with the indicator “!”, in other words, in the case where the repair performed is not compliant with the regulation, the DB updater 90 also updates the equipment list 47 with this result.

Note that, in the above-described embodiment, all of the parts, tools, and materials selectable for the equipment to be repaired are displayed in the parts selection section 22e and the tools and materials selection section 22f in the repair information input screen 22 by way of example. Alternatively, the parts, the tools, and the materials which are not compliant with the regulation may not be displayed in the parts selection section 22e and the tools and materials selection section 22f. This certainly eliminates the possibility of selecting the parts, the tools, and the materials which are not compliant with the regulation at the time of the repair.

(Regulation Information Input Mode)

Next, an operation of each section of the application server 30 in the regulation information input mode is described.

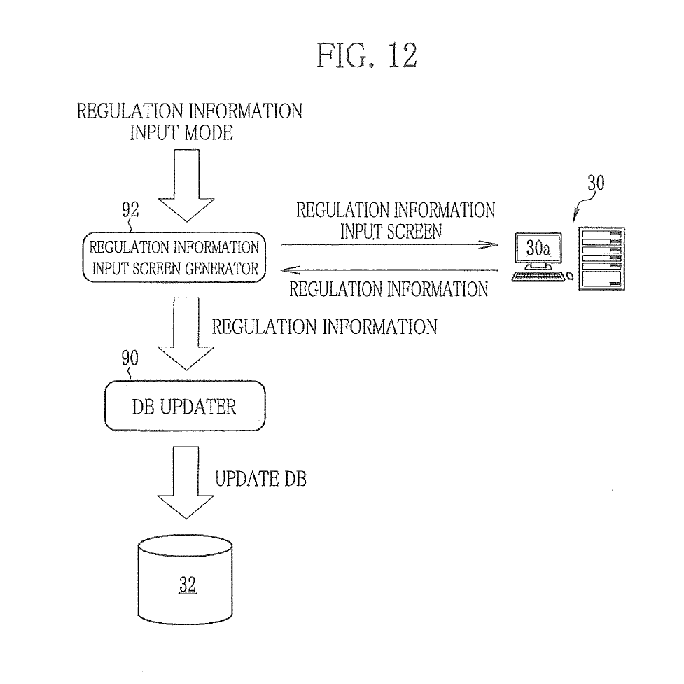

As shown in FIG. 12, in a case where the regulation information input mode is selected through the mode selection screen 70, in other words, in a case where the operation tag 70b is operated on the mode selection screen 70, the regulation information input screen generator 92 and the DB updater 90 are activated.

The regulation information input screen generator 92 generates the repair information input screen 22 based on the language ID stored in the memory 62 by the display language determiner 82, the term correspondence table 40, and the template information stored as the display data 72 in the storage device 60 and with the use of the country-specific terms of the language which corresponds to the language ID, and allows displaying the repair information input screen 22 on the display 30a of the application server 30.

As shown in FIG. 13, the regulation information input screen 41 is provided with a list display and edit section 41a, a list switching tag 41b, and an input end tag 41c. The list display and edit section 41a displays the parts list 42 or the tools and materials list 43. The type of the list displayed in the list display and edit section 41a is switched by operating the list switching tag 41b. In the list display and edit section 41a, a cell in the displayed list is selected, and the content of the selected cell is edited, in other words, the regulation information is inputted to (or edited in) the selected cell.

The input end tag 41c is operated to end editing the parts list 42 or the tools and materials list 43. In response to the operation of the input end tag 41c, the information inputted through the regulation information input screen 41 is transmitted (inputted) to the DB updater 90. The DB updater 90 updates the parts list 42 and the tools and materials list 43 based on the transmitted information.

When the parts list 42 or the tools and materials list 43 is updated, the DB updater 90 updates the equipment list 47 of the equipment which corresponds to the part, tool, or material updated. To be more specific, in a case where new regulation information is inputted and the parts list 42 and the tools and materials list 43 are updated, a model which was compliant with the regulation before the update (the input of the new regulation information) may become non-compliant with the new regulation after the update. The DB updater 90 updates the equipment list 47 to reflect a change in the state of compliance of the endoscope 12 (that is, whether the endoscope 12 is compliant with the regulation) due to the input of the new regulation information.

(Regulatory Compliance Check Mode)

Lastly, an operation of each section of the application server 30 in the regulatory compliance check mode is described.

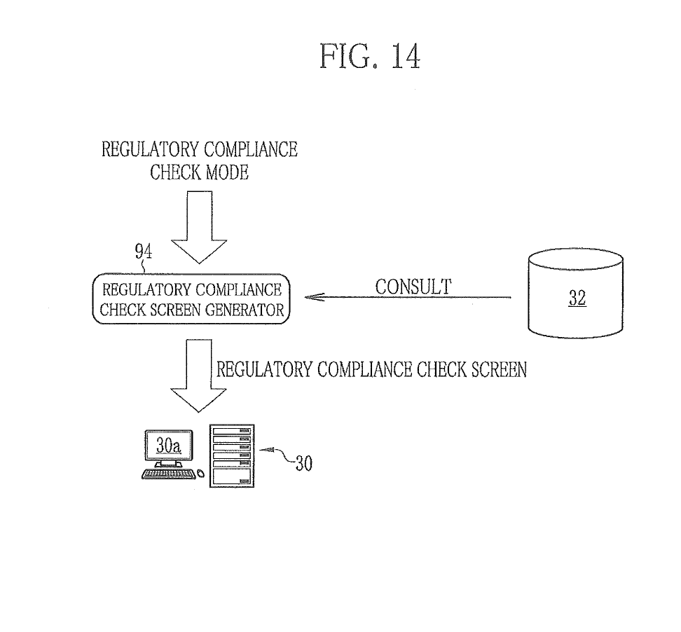

As shown in FIG. 14, in a case where the regulatory compliance check mode is selected through the mode selection screen 70, in other words, in the case where the operation tag 70c on the mode selection screen 70 is operated, the regulatory compliance check screen generator 94 is activated.

The regulatory compliance check screen generator 94 generates the regulatory compliance check screen 44 based on the language ID stored in the memory 62 by the display language determiner 82, the term correspondence table 40, and the template information stored as the display data 72 in the storage device 60 and with the use of the country-specific terms of the language corresponding to the language ID, and displays the regulatory compliance check screen 44 on the display 30a of the application server 30.

As shown in FIG. 15, the regulatory compliance check screen 44 is provided with a non-compliant repair display section 44a, a non-compliant part display section 44b, a non-compliant tools and materials display section 44c, and a non-compliant equipment display section 44d. The non-compliant repair display section 44a displays a repair which is not compliant with the regulation. The repair information of the non-compliant repair with the indicator “!” is extracted from the repair information list 46 and displayed in the non-compliant repair display section 44a. The non-compliant part display section 44b displays a part which is not compliant with the regulation. The part which is associated with the regulation information is extracted from the parts list 42 and displayed in the non-compliant part display section 44b. The non-compliant tools and materials display section 44c displays a non-compliant tool and/or a non-compliant material. The tool and/or the material associated with the regulation information is extracted from the tools and materials list 43 and displayed in the non-compliant tools and materials display section 44c. The non-compliant equipment display section 44d displays the non-compliant endoscope 12. The non-compliant endoscope 12 with the indicator “ ” is extracted from the equipment list 47 and displayed in the non-compliant equipment display section 44d.

As described above, the non-compliant repair that is not compliant with the regulation, the product (the endoscope) which is not compliant with the regulation due to the non-compliant repair, the non-compliant part, the non-compliant tool and/or the non-compliant material, and the non-compliant equipment are displayed in the regulatory compliance check screen 44. Thus, it is easy to grasp whether each of the repairs, the products (equipment), the parts, the tools, and the materials is compliant with the regulation. It is also easy to take measures against those which are not compliant with the regulation.

Note that the configuration or screen layout of the regulatory compliance check screen may be changed as appropriate as long as the state of compliance of the endoscope or the repair, which is managed by the repair information management system, with the regulation (e.g. whether the endoscope or the repair is compliant with the regulation or timing or reasons for being not compliant with the regulation) is checked on the regulatory compliance check screen.

For example, instead of extracting those which are not compliant with the regulation from each of the repair information list, the parts list, the tools and materials list, and the equipment list, the lists may be simply displayed. The indicators and the regulation information associated with the items in the displayed lists allow checking the state of compliance with the regulation.

A refined search may be performed for the information to be displayed in the regulatory compliance check screen. In this case, for example, at least one of four types (repairs, parts, tools and materials, and equipment (product)) may be selected and only the selected type(s) is displayed. The model ID and the serial number of equipment may be inputted and only the information related to the equipment may be displayed. The country (or region) where the equipment is used may be inputted and only the contents relevant to the country (or region) may be displayed. Furthermore, the repair center may be selected and only the repairs performed in the selected repair center or the endoscopes repaired in the selected repair center may be displayed.

In addition, a drawing, a table, or a graph which provides statistics of the state of compliance with the regulation may be displayed on the regulatory compliance check screen. In this case, for example, the drawing, the table, or the graph may provide the number of non-compliant repairs per repair center, the number of non-compliant equipment, the non-compliant parts, or the non-compliant tools and materials on a country-by-country basis, or a change in the number of the non-compliant equipment, the non-compliant parts, or the non-compliant tools and materials.

The regulatory compliance check screen may display a change in the state of compliance with the regulation for each equipment, part, tool, or material. In this case, for example, timing and reasons for becoming not compliant with the regulation may be displayed chronologically from the manufacture or shipment of the equipment to the present.

Thus, the configuration or screen layout of the regulatory compliance check screen or how the information stored in the DB is extracted and displayed is changed in accordance with the needs of the user.

In the present invention, the information of the parts replaced by the repairs and the tools and the materials used for the repair are stored in the form of the list (s) such as the repair information list 46. When and where a part was replaced, and by which part the part was replaced, and when and where the repair was performed, and which tool or material was used for the repair are easily found by consulting, for example, the regulatory compliance check screen 44, the repair information list 46, and the equipment list 47. The history of the parts, the tools, and the materials used for the repair may be displayed not only for the equipment (the non-compliant product) non-compliant with the regulation but also for the equipment (the compliant product) compliant with the regulation.

The information stored in the DB is not limited to that described in the above-described examples and may be changed as necessary. For example, regulations may differ in priority. There may be regulations which are regulated by important laws and violation of which seriously undermines the credibility of the manufacturer. There may be voluntary restraints imposed by the manufacturer. Inadvertent violation of such restraints may occur but does not result in a serious problem. In the case where there are regulations with different priorities, information which indicates the priority for compliance may be associated with each item in the parts list or the tools and materials list and stored in the DB. The repairs, the parts, the tools and materials, and the equipment which are not compliant with the regulations may be arranged in the increasing or decreasing order of priority for compliance in the regulatory compliance check screen. A warning message may be displayed in a case where the repair, the part, the tool, the material, or the equipment is not compliant with the regulation with a high priority for compliance.

In some countries and regions, replacement of parts in equipment approved by a law or the like is prohibited, and the equipment is regarded and treated as a non-approved product after the replacement. In this case, the regulation is imposed not on a part but on a repair action (e.g. replacement). Such regulation imposed on the repair action may be stored in the DB. This allows checking the regulated repair action on the regulatory compliance check screen, and displaying a warning message for the repair action which is not compliant with the regulation.

Information which indicates whether equipment, a part, a tool, or a material is in an approved state may be stored in the DB. This allows checking the state of approval (e.g. whether and when equipment, a part, a tool, or a material is approved, and timing and reasons for disapproval), in the manner similar to the state of compliance with the regulation, and thus affords convenience.

There are regulations which regulate scrapping and recycling or reusing the equipment (or parts, tools, or materials). The regulations related to scrapping and recycling may be stored as the regulation information in the DB. The information of scrapping and recycling a part replaced at a repair or the like may be inputted to the repair information input screen. The regulation information allows managing the information related scrapping and recycling as a part of the repair information, and checking the state of compliance with the regulation related to scrapping and recycling on the regulatory compliance check screen.

In the above embodiments, the present invention is applied to the repair information management system which manages the repair information of the endoscopes, by way of example. The present invention may be applied to a repair information management system which manages repair information of medical equipment other than the endoscopes.

Various changes and modifications are possible in the present invention and may be understood to be within the present invention.

What is claimed is:

1. A repair information management apparatus for managing repair information of medical equipment, comprising:
an operation screen distributor for distributing operation screens to a plurality of terminals through a network, the repair information being inputted through and displayed on the operation screen; and
a database for storing regulation information related to a regulation on the medical equipment or each part constituting the medical equipment, the regulation information being stored in the database for the purpose of displaying whether the medical equipment or the part constituting the medical equipment is a compliant product that is compliant with the regulation or a non-compliant product that is not compliant with the regulation on the operation screen.

2. The repair information management apparatus according to claim 1, further comprising an operation screen generator for generating the operation screen, the operation screen generator generating the operation screen based on the regulation information, the operation screen displaying whether the equipment or the part constituting the equipment is the compliant product or the non-compliant product.

3. The repair information management apparatus according to claim 2, wherein the operation screen generator generates the operation screen in which additional information is added to the medical equipment or the part constituting the medical equipment displayed, and the additional information indicates whether the medical equipment or the part constituting the medical equipment is the compliant product or the non-compliant product.

4. The repair information management apparatus according to claim 2, wherein the operation screen generator determines, based on the regulation information, whether to display the medical equipment or the part constituting the medical equipment on the operation screen, and generates the operation screen.

5. The repair information management apparatus according to claim 1, wherein the regulation information stored in the database includes regulation information related to the regulation on tools and materials used for a repair of the medical equipment, in addition to the regulation information related to the regulation on the medical equipment or the each part constituting the medical equipment.

6. The repair information management apparatus according to claim 1, wherein the operation screens include a parts selection screen for displaying selectable parts for a repair of the medical equipment and allowing selecting the part to be used for the repair from the selectable parts.

7. The repair information management apparatus according to claim 1, wherein the operation screens include a parts list display screen for displaying a list of the parts constituting the medical equipment.

8. The repair information management apparatus according to claim 1, wherein the operation screens include a medical equipment list display screen for displaying a list of the medical equipment.

9. The repair information management apparatus according to claim 1, wherein the operation screens include a repair history display screen for displaying a repair history.

10. The repair information management apparatus according to claim 1, wherein the operation screens include a time-series compliance check screen for chronologically displaying, for the medical equipment or the part constituting the medical equipment, whether the medical equipment or the part constituting the medical equipment is the compliant product or the non-compliant product.

11. A repair information management system for managing repair information of medical equipment, comprising:
a plurality of terminals; and
a repair information management apparatus comprising an operation screen distributor and a database, the operation screen distributor distributing operation screens to the terminals through a network, the repair information being inputted through and displayed on the operation screen, the database storing regulation information related to a regulation on the medical equipment or each part constituting the medical equipment, the regulation information being stored in the database for the purpose of displaying whether the medical equipment or the part constituting the medical equipment is a compliant product that is compliant with the regulation or a non-compliant product that is not compliant with the regulation on the operation screen.

12. A method for managing repair information of medical equipment, comprising the steps of:
distributing operation screens to a plurality of terminals through a network, the repair information being inputted through and displayed on the operation screen;
consulting a database which stores regulation information related to a regulation and determining whether the medical equipment or a part constituting the medical equipment is a compliant product that is compliant with the regulation or a non-compliant product that is not compliant with the regulation; and
displaying whether the medical equipment or the part constituting the medical equipment is the compliant product or the non-compliant product on the operation screen.
